(19) United States
(12) Patent Application Publication
(10) Pub. No.: US 2025/0051689 A1
(43) Pub. Date: Feb. 13, 2025

(54) CLEANING AGENT COMPOSITION

(71) Applicant: KAO CORPORATION, Tokyo (JP)

(72) Inventor: Dongyao LI, Wakayama-shi (JP)

(73) Assignee: KAO CORPORATION, Tokyo (JP)

(21) Appl. No.: 18/720,304

(22) PCT Filed: Dec. 9, 2022
(86) PCT No.: PCT/JP2022/045429

§ 371 Date: Jun. 14, 2024

(30) Foreign Application Priority Data
Dec. 20, 2021 (JP) 2021-205711

(51) Int. Cl. C11D 1/86; B08B 3/00; B08B 3/08; C11D 1/22; C11D 1/62; C11D 1/66; C11D 1/72; C11D 1/75; C11D 3/20; C11D 3/33; C11D 17/00

(52) U.S. Cl. CPC C11D 1/86; B08B 3/003; B08B 3/08; C11D 3/2086; C11D 3/33; C11D 17/0043; B08B 2220/00; C11D 1/22; C11D 1/62; C11D 1/662; C11D 1/72; C11D 1/75

(57) ABSTRACT

A cleaning agent composition containing, (a) a nonionic surfactant containing a polyoxyalkylene alkyl or alkenyl amine [hereinafter referred to as component (a1)] in which the alkyl group or alkenyl group has 8 or more and 18 or less carbons and the oxyalkylene group has an average number of added moles of 1 or more and 8 or less, (b) a quaternary ammonium salt-type surfactant [hereinafter referred to as component (b)], (c) a polycarboxylic acid or a salt thereof, and water, wherein a content of (d) an anionic surfactant [hereinafter referred to as component (d)] is less than 35 mass % relative to a total content of components (a1) and (b), and the content of component (d) is 20 mass % or less relative to a content of all surfactants. The cleaning composition has excellent cleaning power for oil stains and denatured oil stains, and in a method of cleaning such stains.

### FIELD OF THE INVENTION

The present invention relates to a cleaning agent composition and a method for cleaning a denatured oil stain.

### BACKGROUND OF THE INVENTION

Generally, as kitchen cleaning agents used for kitchen items such as microwave ovens, ovens, walls or floors around microwave ovens, and extractor fans, or as cleaning agents used for food processing facilities, cleaning agents containing surfactants, solvents and alkali agents or the like are used for removing oil stains denatured by the action of heat, sunlight, oxygen in the air and others. However, there are problems with cleaning agents containing alkali agents, such as strong irritation to the skin or the like, and others, and they need to be handled with care. Further, workers not used to handling strong alkalis, such as part-time workers or the like, are increasing. Thus, there is a strong need for technology that allows denatured oil stains which are generally stubborn and difficult to remove to be cleaned by easy-to-handle neutral cleaning agents.

Further, in a method generally performed for cleaning tableware and/or kitchen items, a water-soaked sponge or the like is impregnated with a cleaning agent and rubbed several times to make foam, and an object is scrubbed and cleaned. This method was considered as a process necessary to remove stubborn stains such as oil and fat stains derived from food or the like, but was inconvenient when cleaning containers or tools with narrow crevices or depth not reached by sponges. For eliminating such inconvenience, there is a need for technology that achieves high cleaning power only by foaming a cleaning agent with a sprayer having a foam forming mechanism, allowing the foam to adhere to an object, and after leaving them for a certain period of time, rinsing the object with water without scrubbing.

JP-A 2020-97711 discloses a neutral cleaning agent composition containing a mono or polyoxyethylene alkyl or alkenyl amine and a specific solvent.

JP-A 2015-166409 discloses a technology of a cleaning agent composition for hard surfaces containing a mono or polyoxyethylene alkyl or alkenyl amine and a polycarboxylic acid such as citric acid or the like as a solubilizing agent.

JP-A 2000-282083 discloses a technology of a wiping-off cleaning agent composition containing a cationic surfactant and monooxyethylene dodecyl amine or polyoxyethylene dodecyl amine as a nonionic surfactant.

JP-A 2001-247892 discloses a technology of a cleaning agent composition for floor surfaces containing polyoxyethylene (5 moles added) coco amine, a cationic surfactant and ethylenediaminetetraacetic acid.

### SUMMARY OF THE INVENTION

However, there is a need for a cleaning agent composition having even higher cleaning power for denatured oil than the cleaning agent compositions described in these patent literatures.

In the present invention, denatured oil stains refer to oil stains denatured by the action of heat, light, oxygen in the air and others to become stains very difficult to remove.

The present invention provides a cleaning agent composition having excellent cleaning power for oil stains such as denatured oil stains or the like, and a method for cleaning a denatured oil stain.

The present invention relates to a cleaning agent composition containing, (a) a nonionic surfactant [hereinafter referred to as component (a)] containing a polyoxyalkylene alkyl or alkenyl amine [hereinafter referred to as component (a1)] in which the alkyl group or alkenyl group has 8 or more and 18 or less carbons and the oxyalkylene group has an average number of added moles of 1 or more and 8 or less, (b) a quaternary ammonium salt-type surfactant [hereinafter referred to as component (b)], (c) a polycarboxylic acid or a salt thereof [hereinafter referred to as component (c)] and water, wherein a content of (d) an anionic surfactant [hereinafter referred to as component (d)] is less than 35 mass % relative to a total content of components (a1) and (b), and the content of component (d) is 20 mass % or less relative to a content of all surfactants.

Further, the present invention relates to a method for cleaning a denatured oil stain including, bringing the cleaning agent composition of the present invention or a cleaning liquid obtained by diluting the same with water into contact with a hard article adhered with an oil stain including a denatured oil stain.

According to the present invention, provided are a cleaning agent composition having excellent cleaning power for oil stains such as denatured oil stains or the like, and a method for cleaning a denatured oil stain.

### EMBODIMENTS OF THE INVENTION

While a mechanism of action whereby the effect of the present invention is expressed is not necessarily fully elucidated, the applicant believes the following.

Component (a1) of the present invention is a nonionic surfactant, and is a surfactant having high cleaning power for denatured oil stains due to its emulsifying action. Further, oil stains emulsified by component (a1) can be stabilized with emulsified in a cleaning liquid by component (a2), an optional component of the present invention described later. On the other hand, there is the problem that, when an anionic surfactant is coexistent with component (a1) in a cleaning agent composition, component (a1) and the anionic surfactant form a composite, and expected cleaning power for denatured oil stains cannot be attained. Further, in denatured oil stains, many fatty acids such as oleic acid and others are present other than oil and fat. Thus, component (a1) and fatty acids form composites to cause reduction of cleaning power for denatured oil stains. However, in the cleaning agent composition of the present invention, the quaternary ammonium salt-type surfactant of component (b) forms composites with fatty acids contained in denatured oil stains more strongly than component (a1), and thus, the presence of component (b) suppresses reduction of the cleaning power of component (a1). It is further inferred that the polycarboxylic acid or salt thereof of component (c) forms a composite with component (a) to have an effect of further enhancing cleaning power for denatured oil stains.

Note that the mechanism of action whereby the effect of the present invention is expressed is not limited to the above.

### [Cleaning Agent Composition]

<Component (a)>

The cleaning agent composition of the present invention contains as component (a), a nonionic surfactant containing (a1) a polyoxyalkylene alkyl or alkenyl amine in which the alkyl group or alkenyl group has 8 or more and 18 or less carbons and the oxyalkylene group has an average number of added moles of 1 or more and 8 or less.

Component (a1) is a polyoxyalkylene alkyl or alkenyl amine in which the alkyl group or alkenyl group has 8 or more and 18 or less carbons and the oxyalkylene group has an average number of added moles of 1 or more and 8 or less.

Component (a1) has an alkyl group or an alkenyl group with 8 or more and preferably 10 or more, and 18 or less, preferably 16 or less and more preferably 14 or less carbons from the viewpoint of cleaning power for denatured oil stains (hereinafter also simply referred to as cleaning power).

Component (a1) preferably has an alkyl group.

The oxyalkylene group is preferably an oxyalkylene group with 2 carbons and/or an oxyalkylene group with 3 carbons, in other words, an oxyethylene group and/or an oxypropylene group, and more preferably an oxyethylene group. Component (a1) preferably includes an oxyethylene group as the oxyalkylene group.

The oxyalkylene group of component (a1) has an average number of added moles of 1 or more and preferably 2 or more, and 8 or less, preferably 5 or less and more preferably 4 or less from the viewpoint of cleaning power.

Examples of component (a1) include, for example, an alkylene oxide adduct of a monoamine in which an alkyl group or an alkenyl group has 8 or more and 18 or less carbons and the oxyalkylene group has an average number of added moles of 1 or more and 8 or less.

Examples of component (a1) include, for example, a compound represented by the following general formula (a1),

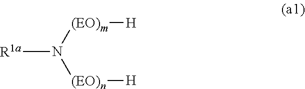

wherein R^{1a} is an alkyl group or an alkenyl group with 8 or more and 18 or less carbons, EO is an ethyleneoxy group, m and n are average numbers of added moles and independently represent numbers of 0 or more and 5 or less, and a total of m and n is 1 or more and 8 or less.

In the formula (a1), R^{1a} has 8 or more and preferably 10 or more, and 18 or less, preferably 16 or less and more preferably 14 or less carbons from the viewpoint of cleaning power. R^{1a} is preferably an alkyl group. The total of m and n is 1 or more and preferably 2 or more, and 8 or less, preferably 5 or less and more preferably 4 or less from the viewpoint of cleaning power.

The cleaning agent composition of the present invention preferably contains one or more selected from (a2) an amine oxide-type surfactant (hereinafter referred to as component (a2)), (a3) an alkyl glycoside-type surfactant (hereinafter referred to as component (a3)) and (a4) an alkyl glyceryl ether-type surfactant (hereinafter referred to as component (a4)) and more preferably contains components (a2), (a3) and (a4) as component (a) other than component (a1) from the viewpoints of cleaning power and aesthetic appearance.

A compound of the following general formula (a2) is suitable as the amine oxide-type surfactant of component (a2),

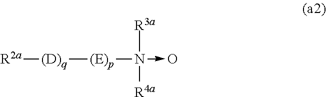

wherein R^{2a} represents a hydrocarbon group, preferably an alkyl group or an alkenyl group and more preferably an alkyl group with 7 or more and 18 or less carbons, R^{3a} and R^{4a} are the same or different and represent alkyl groups with 1 or more and 3 or less carbons, D represents —NHC(═O)— group or —C—(═O)NH— group, E represents an alkylene group with 1 or more and 5 or less carbons, and q and p represent q=0 and p=0 or q=1 and p=1.

In the general formula (a2), when q=1 and p=1, R^{2a} is a hydrocarbon group, preferably an alkyl group or an alkenyl group and more preferably an alkyl group preferably with 7 or more and preferably 9 or more, and 17 or less and preferably 15 or less carbons from the viewpoints of cleaning power and aesthetic appearance, and from the viewpoint of foamability. Further, when q=0 and p=0, R^{2a} is a hydrocarbon group, preferably an alkyl group or an alkenyl group and more preferably an alkyl group preferably with 8 or more and preferably 10 or more, and 18 or less and preferably 16 or less carbons from the viewpoints of cleaning power, aesthetic appearance and foamability. In the present invention, q=0 and p=0 is preferable. R^{3a} and R^{4a} are preferably methyl groups with one carbon from the viewpoints of cleaning power, aesthetic appearance and foamability.

Preferable specific examples of component (a2) include
(1) alkyl (with 8 or more and 18 or less carbons) dialkyl (with 1 or more and 3 or less carbons) amine oxides: capryl dimethylamine oxide, capric dimethylamine oxide, lauryldimethylamine oxide, myristyl dimethylamine oxide, palmityl dimethylamine oxide, stearyl dimethylamine oxide and others, and
(2) amide group containing-type amine oxides (compounds of the general formula (a2) in which q=1 and p=1): caprylic acid amidopropyl dimethylamine oxide, capric acid amidopropyl dimethylamine oxide, lauric acid amidopropyl dimethylamine oxide, myristic acid amidopropyl dimethylamine oxide and others, and one or two or more of these can be used.

A compound represented by the following general formula (a3) is preferable as the alkyl glycoside-type surfactant of component (a3),

R^{5a}—(OR^{6a})ₓG_{y} (a3)

wherein R^{5a} is a hydrocarbon group, preferably an alkyl group or an alkenyl group and more preferably an alkyl group with 8 or more and preferably 10 or more, and 18 or less and preferably 16 or less carbons, R^{6a} is an alkylene group with 2 or more and 4 or less carbons, preferably an ethylene group or a propylene group and more preferably an ethylene group, G is a residue derived from a reducing sugar, x is an average number of added moles of OR^{6a} and represents a number of 0 or more and 6 or less, and y is an average degree of condensation of G and represents a number of 1 or more, and 10 or less, preferably 5 or less and more preferably 2 or less.

In the compound of the general formula (a3), G is a residue derived from a reducing sugar, and the reducing sugar of a raw material of G may be either an aldose or a ketose. Further, examples of the reducing sugar of a raw material of G can include a triose with 3 carbons, a tetrose with 4 carbons, a pentose with 5 carbons or a hexose with 6 carbons. Specific examples of the aldose can include apiose, arabinose, galactose, glucose, lyxose, mannose, gulose, an aldose, idose, talose or xylose. Further, specific examples of the ketose can include fructose. Among these, the reducing sugar of a raw material of G of the present invention is an aldopentose, an aldose with 5 carbons, or an aldohexose, an aldose with 6 carbons and more preferably glucose from the viewpoints of cleaning power, aesthetic appearance and foamability.

As the alkyl glyceryl ether-type surfactant of component (a4), an alkyl glyceryl ether-type surfactant having one hydrocarbon group, preferably alkyl group or alkenyl group, more preferably alkyl group and further preferably branched alkyl group with 6 or more and preferably 8 or more, and 12 or less and preferably 10 or less carbons is suitable from the viewpoints of cleaning power and aesthetic appearance.

<Component (b)>

The cleaning agent composition of the present invention contains a quaternary ammonium salt-type surfactant as component (b).

The quaternary ammonium salt-type surfactant of component (b) is preferably one or more selected from a compound represented by the following general formula (b1) and a compound represented by the following general formula (b2),

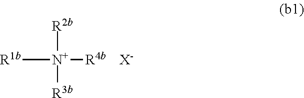

wherein R^{1b} is an aliphatic hydrocarbon group with 8 or more and 18 or less carbons, R^{2b} is a group selected from an aliphatic hydrocarbon group with 8 or more and 18 or less carbons, an alkyl group with 1 or more and 3 or less carbons and a hydroxyalkyl group with 1 or more and 3 or less carbons, R^{3b} and R^{4b} are each independently a group selected from an alkyl group with 1 or more and 3 or less carbons and a hydroxyalkyl group with 1 or more and 3 or less carbons, and X⁻ is an anion, and

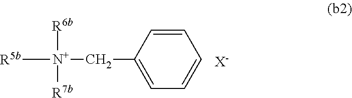

wherein R^{5b} is an aliphatic hydrocarbon group with 8 or more and 18 or less carbons, R^{6b} and R^{7b} are each independently a group selected from an alkyl group with 1 or more and 3 or less carbons and a hydroxyalkyl group with 1 or more and 3 or less carbons, and X⁻ is an anion.

In the general formula (b1), R^{1b} has preferably 9 or more, more preferably 10 or more, further preferably 12 or more and furthermore preferably 14 or more, and preferably 16 or less carbons from the viewpoint of cleaning power. R^{1b} is preferably an alkyl group or an alkenyl group and preferably an alkyl group.

In the general formula (b1), R^{2b} is a group selected from an aliphatic hydrocarbon group with 8 or more and 18 or less carbons, an alkyl group with 1 or more and 3 or less carbons and a hydroxyalkyl group with 1 or more and 3 or less carbons.

When R^{2b} is an aliphatic hydrocarbon group with 8 or more and 18 or less carbons, R^{2b} is preferably an alkyl group or an alkenyl group and preferably an alkyl group with preferably 8 or more, and preferably 14 or less and more preferably 12 or less carbons from the viewpoint of cleaning power.

In the general formula (b1), R^{3b} and R^{4b} are each independently a group selected from an alkyl group with 1 or more and 3 or less carbons and a hydroxyalkyl group with 1 or more and 3 or less carbons. R^{3b} and R^{4b} are preferably each independently a group selected from an alkyl group with 1 or more and 3 or less carbons. Examples of the alkyl group with 1 or more and 3 or less carbons include a methyl group, an ethyl group or a propyl group. Examples of the hydroxyalkyl group with 1 or more and 3 or less carbons include a hydroxymethyl group, a hydroxyethyl group or a hydroxypropyl group.

In the general formula (b1), X⁻ is an anion. Examples of the anion include halogen ions, for example, a chloride ion, a bromide ion and an iodide ion. Further, examples include alkyl sulfate ions with 1 or more and 3 or less carbons, for example, a methyl sulfate ion, an ethyl sulfate ion and a propyl sulfate ion.

Examples of a preferable compound of the compound of the general formula (b1) include one or more selected from an N-alkyl-N,N,N-trimethylammonium salt having an alkyl group with 12 or more and 18 or less carbons, an N,N-dialkyl-N,N-dimethyl-ammonium salt having an alkyl group with 8 or more and 16 or less carbons and an N-alkyl-N,N-dimethyl-N-ethylammonium salt having an alkyl group with 12 or more and 16 or less carbons.

In the general formula (b2), R^{5b} is an aliphatic hydrocarbon group with 8 or more and 18 or less carbons. R^{5b} has preferably 8 or more, and preferably 18 or less and more preferably 16 or less carbons from the viewpoint of cleaning power. R^{5b} is preferably an alkyl group or an alkenyl group and preferably an alkyl group.

In the general formula (b2), R^{6b} and R^{7b} are each independently a group selected from an alkyl group with 1 or more and 3 or less carbons and a hydroxyalkyl group with 1 or more and 3 or less carbons. R^{6b} and R^{7b} are preferably each independently a group selected from an alkyl group with 1 or more and 3 or less carbons. Examples of the alkyl group with 1 or more and 3 or less carbons include a methyl group, an ethyl group or a propyl group. Examples of the hydroxyalkyl group with 1 or more and 3 or less carbons include a hydroxymethyl group, a hydroxyethyl group or a hydroxypropyl group.

In the general formula (b2), X⁻ is an anion. Examples of the anion include halogen ions, for example, a chloride ion, a bromide ion and an iodide ion. Further, examples include alkyl sulfate ions with 1 or more and 3 or less carbons, for example, a methyl sulfate ion, an ethyl sulfate ion and a propyl sulfate ion.

Specific examples of the compound of the general formula (b2) include one or more compounds selected from an N-dodecyl-N,N-dimethyl-N-benzyl ammonium salt, an N-tridecyl-N,N-dimethyl-N-benzyl ammonium salt, an N-tetradecyl-N,N-dimethyl-N-benzyl ammonium salt, an N-pentadecyl-N,N-dimethyl-N-benzyl ammonium salt, an N-hexadecyl-N,N-dimethyl-N-benzyl ammonium salt, an N-dodecyl-N,N-diethyl-N-benzyl ammonium salt, an N-tridecyl-N,N-diethyl-N-benzyl ammonium salt, an N-tetradecyl-N,N-diethyl-N-benzyl ammonium salt, an N-pentadecyl-N,N-diethyl-N-benzyl ammonium salt, an N-hexadecyl-N,N-diethyl-N-benzyl ammonium salt, an N-dodecyl-N-methyl-N-ethyl-N-benzyl ammonium salt, an N-tridecyl-N-methyl-N-ethyl-N-benzyl ammonium salt, an N-tetradecyl-N-methyl-N-ethyl-N-benzyl ammonium salt, an N-pentadecyl-N-methyl-N-ethyl-N-benzyl ammonium salt and an N-hexadecyl-N-methyl-N-ethyl-N-benzyl ammonium salt.

<Component (c)>

The cleaning agent composition of the present invention contains a polycarboxylic acid or a salt thereof as component (c).

Component (c) has a molecular weight of preferably 100 or more, more preferably 130 or more and further preferably 150 or more, and preferably 300 or less, more preferably 270 or less and further preferably 250 or less in terms of an acid equivalent form from the viewpoint of cleaning power.

A valence of the carboxylic acid of component (c) is preferably divalence or more, and preferably tetravalence or less and more preferably trivalence or less from the viewpoint of cleaning power.

In the present invention, in the case of a divalent or trivalent polycarboxylic acid, a polycarboxylic acid with a molecular weight of 130 or more and 250 or less is preferable, and in the case of a tetravalent carboxylic acid, a polycarboxylic acid with a molecular weight of 280 or more and 300 or less is preferable.

Examples of component (c) include one or more selected from citric acid (MW: 192, trivalent), malic acid (MW: 134, divalent), oxalic acid (MW: 90, divalent), malonic acid (MW: 104, divalent), succinic acid (MW: 118, divalent), tartaric acid (MW: 150, divalent), glutaric acid (MW: 132, divalent), adipic acid (MW: 146, divalent), fumaric acid (MW: 116, divalent), maleic acid (MW: 116, divalent), aconitic acid (MW: 174, trivalent), ethylenediaminetetraacetic acid (EDTA) (MW: 292, tetravalent), nitrilotriacetic acid (NTA) (MW: 191, trivalent), methylglycinediacetic acid (MGDA) (MW: 205 trivalent), glutamic acid diacetic acid (GLDA) (MW: 259, tetravalent) and salts of these. In the parentheses for each component, the molecular weight in terms of the acid equivalent form and the valence of the carboxylic acid are shown.

Examples of a salt of component (c) include an alkali metal salt, an alkaline earth metal salt, an ammonium salt or the like. Examples of the alkali metal salt include a sodium salt or a potassium salt.

From the viewpoint of cleaning power, component (c) is preferably one or more selected from citric acid, malic acid, MGDA, GLDA, EDTA, succinic acid, maleic acid, adipic acid, maleic acid, fumaric acid, malonic acid and salts of these, more preferably one or more selected from citric acid, malic acid, MGDA, GLDA, EDTA and salts of these, and further preferably one or more selected from citric acid, malic acid, EDTA and salts of these. In the present invention, citric acid or a salt thereof is the most preferable.

<Composition and others>

The cleaning agent composition of the present invention contains component (a) in an amount of preferably 0.5 mass % or more, more preferably 1 mass % or more, further preferably 3 mass % or more and furthermore preferably 5 mass % or more, and preferably 30 mass % or less, more preferably 25% mass or less, further preferably 20 mass % or less, furthermore preferably 15 mass % or less and furthermore preferably 10 mass % or less in the cleaning agent composition from the viewpoint of cleaning power.

In the cleaning agent composition of the present invention, a content of component (a1) in component (a) is preferably 10 mass % or more, more preferably 15 mass % or more and further preferably 20 mass % or more, and preferably 100 mass % or less, more preferably 70 mass % or less, further preferably 50 mass % or less, furthermore preferably 45 mass % or less and furthermore preferably 40 mass % or less from the viewpoint of cleaning power.

The cleaning agent composition of the present invention contains component (b) in an amount of preferably 0.01 mass % or more, more preferably 0.05 mass % or more and further preferably 0.1 mass % or more, and preferably 10 mass % or less, more preferably 5 mass % or less, further preferably 2 mass % or less, furthermore preferably 1 mass % or less and furthermore preferably 0.7 mass % or less in the cleaning agent composition from the viewpoint of cleaning power.

In the present invention, values expressed in terms of a chloride salt equivalent are used for specifications relating to the mass of component (b).

In the cleaning agent composition of the present invention, a mass ratio of a content of component (a1) to a content of component (b), (a1)/(b), is preferably 0.1 or more, more preferably 0.5 or more, further preferably 1 or more, furthermore preferably 2 or more and furthermore preferably 3 or more, and preferably 200 or less, more preferably 100 or less, further preferably 50 or less, furthermore preferably 40 or less, furthermore preferably 30 or less and furthermore preferably 25 or less from the viewpoint of cleaning power.

The cleaning agent composition of the present invention contains component (c) in an amount of preferably 0.01 mass % or more, more preferably 0.05 mass % or more, further preferably 0.1 mass % or more and furthermore preferably 0.5 mass % or more, and preferably 10 mass % or less, more preferably 5 mass % or less, further preferably 3 mass % or less, furthermore preferably 2 mass % or less and furthermore preferably 1.5 mass % or less in the cleaning agent composition from the viewpoint of cleaning power.

In the present invention, values expressed in terms of an acid equivalent form are used for specifications relating to the mass of component (c).

In the cleaning agent composition of the present invention, a mass ratio of a content of component (a1) to a content of component (c), (a1)/(c), is preferably 0.1 or more, more preferably 0.5 or more and further preferably 1 or more, and preferably 10 or less, more preferably 8 or less, further preferably 4 or less and furthermore preferably 3 or less from the viewpoint of cleaning power.

In the cleaning agent composition of the present invention, a mass ratio of a content of component (b) to a content of component (c), (b)/(c), is preferably 0.01 or more, more preferably 0.05 or more and further preferably 0.09 or more, and preferably 5 or less, more preferably 2 or less, further preferably 1 or less and furthermore preferably 0.8 or less from the viewpoint of cleaning power.

The cleaning agent composition of the present invention may optionally contain an anionic surfactant as component (d), but its content is limited.

Examples of the anionic surfactant can include an alkyl sulfate or a salt thereof, a polyoxyalkylene alkyl ether sulfate or a salt thereof, an alkane sulfonic acid or a salt thereof, an alkylbenzene sulfonic acid or a salt thereof, a higher fatty acid or a salt thereof, a polyoxyethylene alkyl ether carboxylic acid or a salt thereof, an N-acyl amino acid or a salt thereof, an alkyl phosphate or a salt thereof, a polyoxyethylene alkyl ether phosphoric acid or a salt thereof or the like. Examples of the salts include sodium salts, potassium salts or other alkali metal salts, or the like.

In the cleaning agent composition of the present invention, a content of component (d) relative to a total content of components (a1) and (b) (in other words, a mass ratio (d)/((a1)+(b))×100) is preferably 0 mass % or more, and less than 35 mass %, more preferably 20 mass % or less, further preferably 10 mass % or less and furthermore preferably 5 mass % or less from the viewpoints of cleaning power and appearance transparency.

Further, in the cleaning agent composition of the present invention, the content of component (d) is 20 mass % or less, preferably 10 mass % or less, more preferably 3 mass % or less, further preferably 2 mass % or less and furthermore preferably 1 mass % or less relative to a content of all surfactants from the viewpoints of cleaning power and appearance transparency.

In the present invention, values expressed in terms of a sodium salt equivalent are used for specifications relating to the mass of component (d).

The cleaning agent composition of the present invention may be free of component (d).

The cleaning agent composition of the present invention can contain a water-miscible organic solvent as component (e) from the viewpoints of adjustability of viscosity of the composition and gel suppressibility.

A water-miscible organic solvent as used herein refers to a solvent which is soluble in an amount of 50 g or more in 1 L of ion exchange water at 25° C.

Examples of the water-miscible organic solvent include (e1) alkanols such as ethanol, 1-propanol, 2-propanol, 1-butanol and others, (e2) glycols such as propylene glycol, butylene glycol, hexylene glycol and others, (e3) glycols such as diethylene glycol, triethylene glycol, tetraethylene glycol, dipropylene glycol, tripropylene glycol and others, (e4) alkyl ethers such as diethylene glycol monomethyl ether, diethylene glycol dimethyl ether, triethylene glycol monomethyl ether, diethylene glycol monoethyl ether, diethylene glycol monobutyl ether, diethylene glycol diethyl ether, dipropylene glycol monomethyl ether, dipropylene glycol monoethyl ether, tripropylene glycol monomethyl ether, 1-methoxy-2-propanol, 1-ethoxy-2-propanol, 1-methyl glycerin ether, 2-methyl glycerin ether, 1,3-dimethyl glycerin ether, 1-ethyl glycerin ether, 1,3-diethyl glycerin ether, triethyl glycerin ether, 1-pentyl glyceryl ether, 2-pentyl glyceryl ether, 1-octyl glyceryl ether, 2-ethylhexyl glyceryl ether, diethylene glycol monobutyl ether and others, (e5) aromatic ethers such as 2-phenoxyethanol, diethylene glycol monophenyl ether, triethylene glycol monophenyl ether, a polyethylene glycol monophenyl ether with an average molecular weight of about 480, phenoxy propylene glycol, 2-benzyloxyethanol, diethylene glycol monobenzyl ether and others and (e6) ethylene oxide and/or propylene oxide polymers with an average molecular weight of 500 or more and 5000 or less, specifically, a polypropylene glycol with an average molecular weight of from 500 to 5000, a polyethylene glycol with a molecular weight of 500 or more and 5000 or less and an oxypropylene oxyethylene copolymer with a molecular weight of 500 or more and 5000 or less (which may be either block or random), and one or more of these can be used.

From the viewpoint of appearance transparency, component (e) is preferably one or more selected from diethylene glycol monobutyl ether, ethanol, propylene glycol, diethylene glycol, 2-phenoxyethanol and a polypropylene glycol with a molecular weight of 500 or more and 3000 or less, more preferably one or more selected from diethylene glycol monobutyl ether, ethanol, propylene glycol and a polypropylene glycol with a molecular weight of 500 or more and 3000 or less, and further preferably one or more selected from diethylene glycol monobutyl ether and a polypropylene glycol with a molecular weight of 500 or more and 3000 or less.

The cleaning agent composition of the present invention contains component (e) in an amount of preferably 0.1 mass % or more, more preferably 0.5 mass % or more and further preferably 1 mass % or more, and preferably 20 mass % or less, more preferably 10 mass % or less, further preferably 5 mass % or less, furthermore preferably 3 mass % or less and furthermore preferably 2 mass % or less in the cleaning agent composition from the viewpoint of appearance transparency.

The cleaning agent composition of the present invention can be formulated with components such as surfactants, solvents, enzymes (proteolytic enzymes, lipolytic enzymes, glycolytic enzymes and others), hydrotropic agents, pH adjusters, thickening agents, dispersants, viscosity adjusters, fragrances, colorants, antioxidants, antiseptics and others (excluding those which qualify as component (a) including components (a1), (a2), (a3) and (a4), component (b), component (c), component (d) and component (e)) in the range that the purposes of the present invention are not impaired.

The cleaning agent composition of the present invention contains water. Examples of the water are not particularly limited, but include tap water, well water, ion exchange water, distilled water or the like. In the present invention, water is preferably used in an amount of the balance of the cleaning agent composition (an amount which makes the total 100 mass %). A content of water can be, for example, 50 mass % or more, further 60 mass % or more and further 70 mass % or more in the cleaning agent composition.

The cleaning agent composition of the present invention has a pH of preferably 3 or more, more preferably 5 or more and further preferably 6 or more, and preferably 10 or less, more preferably 9 or less and further preferably 8 or less at 20° C. from the viewpoint of ease of handling. Note that the pH is a value determined by a glass electrode method.

The cleaning agent composition of the present invention can be suitably used for hard articles.

The cleaning agent composition of the present invention can be intended for various hard articles, but is preferably used for tableware and/or kitchen hard articles and more preferably used for tableware.

The kitchen hard articles are articles used in and around kitchens, specifically,
(1) storage areas for food, tableware and cooking utensils, such as refrigerators, cupboards and others,
(2) food preparation areas such as drains, cooktops, range hoods, sinks, gas ranges, microwave ovens and others, and
(3) walls or floors around the storage areas or the preparation areas, and others. In the present invention, these are referred to as “kitchen hard articles” for convenience.

Further, specific examples of the tableware include components or utensils coming in contact with foodstuffs, such as
(i) so-called tableware such as plates, bowls and others,
(ii) storage containers such as Tupperware, jars and others,
(iii) cooking utensils such as knives, cutting boards, pots, pans, fish grills and others, and
(iv) cooking appliances such as food processors, mixers and others, or the like. In the present invention, these are referred to as “tableware” for convenience.

Further, the present invention is preferably intended for articles selected from the tableware, storage containers, cooking utensils and cooking appliances and even more preferably intended for articles selected from plates, bowls, Tupperware, jars, knives, cutting boards, pots, pans, fish grills, food processors and mixers.

Examples of materials for the hard articles covered by the present invention include plastic (including silicone resin and others), metal, ceramic, wood and a combination of those. Further, the cleaning agent composition of the present invention can effectively clean oil stains including denatured oil stains adhering to these hard articles.

### <Method for Cleaning Hard Article>

The present invention provides a method for cleaning a denatured oil stain including, bringing the cleaning agent composition of the present invention or a cleaning liquid obtained by diluting the same with water into contact with a hard article adhered with an oil stain including a denatured oil stain. The matters stated in the cleaning agent composition of the present invention can be appropriately applied to the method for cleaning a denatured oil stain of the present invention.

In the method for cleaning a denatured oil stain of the present invention, the cleaning agent composition of the present invention can be foamed and brought into contact with the hard article. For example, the cleaning agent composition of the present invention can be, for example, foamed with a sponge or foamed with a sprayer having a foam forming mechanism and brought into contact with the hard article. Further, the cleaning agent composition of the present invention can be brought into contact with the hard article by spraying, applying, immersion and others.

In the method for cleaning a denatured oil stain of the present invention, the cleaning liquid obtained by diluting the cleaning agent composition of the present invention with water (hereinafter simply referred to as cleaning liquid) may be foamed and brought into contact with the hard article, or the cleaning liquid may be brought into contact with the hard article by spraying, applying, immersion and others.

In the present invention, the cleaning agent composition of the present invention may be diluted when used, but a suitable ratio for dilution with water is preferably 80 times or less and more preferably 40 times or less since too much dilution may impair its effect. The present invention can also be used as a raw solution.

Examples of the target hard article in the method for cleaning a denatured oil stain of the present invention include those which are stated in the cleaning agent composition of the present invention. Tableware is one suitable hard article.

In the method for cleaning a denatured oil stain of the present invention, the stain adhering to the target hard article may be an oil stain including a denatured oil stain, and further, may be a denatured oil stain.

In the method for cleaning a denatured oil stain of the present invention, the hard article adhered with an oil stain including denatured oil, particularly heat denatured oil, and others may be immersed in the cleaning agent composition of the present invention or the cleaning liquid and brought into contact with the cleaning agent composition or the cleaning liquid, but from the viewpoint of efficiently enhancing cleaning power, a preferable method for bringing the cleaning agent composition or the cleaning liquid into contact with the hard article adhered with an oil stain including denatured oil, particularly heat denatured oil, and others is spraying or applying.

A method for bringing the cleaning agent composition of the present invention or the cleaning liquid into contact with the hard article adhered with an oil stain and others is preferably spraying or applying and more preferably spraying it in liquid droplet form or applying it in foam form. Specifically, for example, a spray tool is used for bringing the cleaning agent composition of the present invention or the cleaning liquid into contact with the hard article. In other words, in the present invention, it is preferable to use a cleaning agent for hard articles obtained by filling the cleaning agent composition of the present invention or the cleaning liquid into a container having a sprayer.

Examples of a method for applying it in foam form can include, for example, a method in which air is entrained in the cleaning agent composition of the present invention or the cleaning liquid at a nozzle portion of a sprayer to make foam, or a method in which the cleaning agent composition of the present invention or the cleaning liquid is put on a sponge or a cleaning textile article or the like, and the sponge or cleaning textile article or the like is thereafter rubbed several times to make foam.

The present invention provides a cleaning agent article contained in a spray container obtained by filling the cleaning agent composition of the present invention or the cleaning liquid into the container having a sprayer.

Examples of the container having a sprayer in the cleaning agent article contained in a spray container of the present invention include a manual spray device using no propellant, such as a trigger-type spray container, a pump-type spray container or the like, an aerosol using a propellant, or the like. The container having a sprayer is preferably a trigger-type spray capable of spraying or applying the content in liquid droplet form or foam form, and more preferably a trigger-type spray having a mechanism for spraying the content in liquid droplet form or a trigger-type spray having a mechanism for forming foam (foam forming mechanism).

When a trigger-type spray having a mechanism for spraying the cleaning agent composition of the present invention or the cleaning liquid in liquid droplet form is used in the cleaning agent article contained in a spray container of the present invention, a jet size of a jet nozzle of the spray container containing the cleaning agent composition or the cleaning liquid falls within the range of preferably 0.1 mm or more and more preferably 0.3 mm or more, and preferably 2 mm or less and more preferably 1 mm or less for ease of spraying or for avoiding a coarse jetted liquid droplet, linear spraying or an extremely small sprayable area.

When a trigger-type spray having a mechanism for spraying the content in liquid droplet form is used, the cleaning agent article contained in a spray container of the present invention sprays the composition in an amount of preferably 0.1 mL or more and more preferably 0.3 mL or more, and preferably 5 mL or less and more preferably 2 mL or less per operation.

When a trigger-type spray having a foam forming mechanism is used, the cleaning agent article contained in a spray container of the present invention sprays the composition in an amount of preferably 0.5 mL or more and more preferably 1 mL or more, and preferably 30 mL or less, more preferably 15 mL or less and further preferably 5 mL or less per operation.

In the method for cleaning a denatured oil stain of the present invention, cleaning is carried out by bringing the cleaning agent composition of the present invention or the cleaning liquid into contact with the hard article. In the cleaning method of the present invention, cleaning can be carried out, for example, by leaving the hard article immersed in the cleaning agent composition of the present invention or the cleaning liquid or leaving the hard article coated with the cleaning agent composition of the present invention or the cleaning liquid, followed by rubbing the hard article with a sponge or a textile product, washing the composition or the liquid away with running water, or the like to remove the stain from the hard article. Further, rinsing with running water or the like can be thereafter carried out. The cleaning method of the present invention may be a hand-washing cleaning method, in which a hard article such as tableware or the like can be hand-washed in conformance with a publicly-known technique.

### EXAMPLES

The cleaning agent compositions in Tables 1 to 3 were prepared by using the formulation components below. The cleaning agent compositions in Tables 1 to 3 were each obtained by adding components (a), (b), (c), (d) and (e) in formulation amounts in the tables and dissolving them at a room temperature (20° C.). After formulation, sodium hydroxide was added to adjust a pH to the value shown in the tables. Note that the pH values were measured by a glass electrode method. Further, the mass percentages of the formulation components in Tables 1 to 3 are all numerical values based on effective amounts.

### <Formulation Component>

Component (a)
AMIET 102: polyoxyethylene (2.1) lauryl amine, component (a1), a compound of the general formula (a1) in which R^{1a} is an alkyl group with 12 carbons and m+n is 2.1, manufactured by Kao Corporation
AMIET 105: polyoxyethylene (4) coco alkyl amine, component (a1), a compound of the general formula (a1) in which R^{1a} is an alkyl group with 8 to 18 carbons and m+n is 4, manufactured by Kao Corporation
AMIET 302: polyoxyethylene (2.1) alkyl (C14 to 18) amine, component (a1), a compound of the general formula (a1) in which R^{1a} is an alkyl group with 14 to 18 carbons and m+n is 2.1, manufactured by Kao Corporation
AMPHITOL 20N: lauryldimethylamine oxide, component (a2), a compound of the general formula (a2) in which R^{2a} is an alkyl group with 12 carbons, R^{3a} and R^{4a} are methyl groups, and q is 0 and p is 0, manufactured by Kao Corporation
AMPHITOL 40N: myristyl dimethylamine oxide, component (a2), a compound of the general formula (a2) in which R^{2a} is an alkyl group with 14 carbons, R^{3a} and R^{4a} are methyl groups, and q is 0 and p is 0, manufactured by Kao Corporation
AMPHITOL 08N: capryl dimethylamine oxide, component (a2), a compound of the general formula (a2) in which R^{2a} is an alkyl group with 8 carbons, R^{3a} and R^{4a} are methyl groups, and q is 0 and p is 0, manufactured by Kao Corporation
AG-124: alkyl polyglycoside, component (a3), a compound of the general formula (a3) in which R^{5a} is an alkyl group with 10 to 14 carbons, G is a residue derived from glucose, x is 0, and y is 1.3, manufactured by Kao Corporation
GE-EH: 2-ethylhexyl glyceryl ether, component (a4), manufactured by Kao Corporation
Component (b)
SANISOL B-50: benzyl-alkyl (C12 to 16) dimethyl ammonium chloride, a compound of the general formula (b2) in which R^{5b} is an alkyl group with 12 to 16 carbons (60 mass % of C12, 30 mass % of C14 and 10 mass % of C16), R^{6b} and R^{7b} are methyl groups, and X⁻ is a chloride ion, manufactured by Kao Corporation
LEVENOL RK: benzyl-alkyl (C8 to 18) dimethyl ammonium chloride, a compound of the general formula (b2) in which R^{5b} is an alkyl group with 8 to 18 carbons (80 mass % of C10), R^{6b} and R^{7b} are methyl groups, and X⁻ is a chloride ion, manufactured by Kao Corporation
SANISOL 08: benzyl-octyl dimethyl ammonium chloride, a compound of the general formula (b2) in which R^{5b} is an alkyl group with 8 carbons, R^{6b} and R^{7b} are methyl groups, and X⁻ is a chloride ion, manufactured by Kao Corporation
QUARTAMIN 60W: cetyl trimethyl ammonium chloride, a compound of the general formula (b1) in which R^{1b} is an alkyl group with 16 carbons, R^{2b}, R^{3b} and R^{4b} are methyl groups, and X⁻ is a chloride ion, manufactured by Kao Corporation
Component (c)
Citric acid: molecular weight 192, a trivalent carboxylic acid, manufactured by San Fu Chemical Co., Ltd.
Malic acid: molecular weight 134, a divalent carboxylic acid, manufactured by FUSO CHEMICAL CO., LTD.
MGDA: methylglycinediacetic acid, molecular weight 205, a trivalent carboxylic acid, manufactured by Tokyo Chemical Industry Co., Ltd.
GLDA: glutamic acid diacetic acid, molecular weight 259, a tetravalent carboxylic acid, manufactured by Tokyo Chemical Industry Co., Ltd.
EDTA: ethylenediaminetetraacetic acid, molecular weight 292, a tetravalent carboxylic acid, manufactured by Tokyo Chemical Industry Co., Ltd.
Component (d)
NEOPELEX G-25: sodium alkyl benzene sulfonate (soft type) having an alkyl group with 10 to 14 carbons, manufactured by Kao Corporation Component (e)
BDG: diethylene glycol monobutyl ether, manufactured by SINO-JAPAN CHEMICAL CO., LTD.
PPG-1000: polypropylene glycol, molecular weight 1000, manufactured by AGC Inc.

### <Cleaning Power 1 for Denatured Oil Stain>

An SUS 304 test piece (1.0 mm×25 mm×70 mm) manufactured by Engineering Test Service Co., Ltd., from which a protective film was peeled off, was cleaned with a sponge using a neutral tableware detergent and rinsed (with tap water once and with ion exchange water twice), and dried in an electric dryer at 80° C. to obtain a pretreated SUS plate. The mass of the pretreated SUS plate was weighed on a 4-digit balance to give an initial mass (X).

Denatured oil and chloroform were mixed at a proportion of 20 g/60 ml to prepare a denatured oil/chloroform solution. Here, the denatured oil was prepared by heating rape seed oil (FUJIFILM Wako Pure Chemical Corporation) statically at 180° C. for 8 hours.

The denatured oil/chloroform solution was poured over an area of 25 mm×50 mm on one side of the pretreated SUS plate once with a dropper in an amount of 1 mg/cm². The plate was placed horizontally with the surface adhered with the oil facing upward and dried overnight to obtain an SUS plate for cleaning. The mass of the SUS plate for cleaning was weighed on a 4-digit balance to give a mass before cleaning (Y).

Three SUS plates for cleaning were used per type of the cleaning agent compositions in Tables 1 to 3 to perform evaluations. The three SUS plates for cleaning were put side by side in a balance dish BD-3 (140×140×25 mm), in which they were immersed in 40 ml of a cleaning liquid obtained by diluting each of the cleaning agent compositions in Tables 1 to 3 twenty times with water, and left at 25° C. for 20 minutes. Subsequently, they were rinsed with tap water for 1 minute with mechanical force at 300 rpm using a Leanuts tester, and then placed horizontally and dried overnight. The mass of each SUS plate for cleaning after drying was weighed on a 4-digit balance to give a mass after cleaning (Z).

A cleaning rate was calculated by the formula below from the initial mass (X), the mass before cleaning (Y) and the mass after cleaning (X). The results are shown in Tables 1 to 3.

Cleaning rate (%)=[mass before cleaning(Y)−mass after cleaning(Z)]/[mass before cleaning(Y)−initial mass(X)]×100

### <Cleaning Power 2 for Denatured Oil Stain>

An SUS 304 test piece (1.0 mm×25 mm×70 mm) manufactured by Engineering Test Service Co., Ltd., from which a protective film was peeled off, was cleaned with a sponge using a neutral tableware detergent and rinsed (with tap water once and with ion exchange water twice), and dried in an electric dryer at 80° C. to obtain a pretreated SUS plate. The mass of the pretreated SUS plate was weighed on a 4-digit balance to give an initial mass (X).

Denatured oil and chloroform were mixed at a proportion of 20 g/60 ml to prepare a denatured oil/chloroform solution. Here, the denatured oil was prepared by heating rape seed oil (FUJIFILM Wako Pure Chemical Corporation) statically at 180° C. for 8 hours.

The denatured oil/chloroform solution was poured over an area of 25 mm×50 mm on one side of the pretreated SUS plate once with a dropper in an amount of 1 mg/cm². The plate was placed horizontally with the surface adhered with the oil facing upward and dried overnight to obtain an SUS plate for cleaning. The mass of the SUS plate for cleaning was weighed on a 4-digit balance to give a mass before cleaning (Y).

Three SUS plates for cleaning were used per type of the cleaning agent compositions in Table 3 to perform evaluations. The three SUS plates for cleaning were put side by side in a balance dish BD-3 (140×140×25 mm), in which the SUS plates for cleaning were entirely covered with foam formed by foaming each cleaning agent composition in Table 3 which was filled into a spray container for Bioré u Foam Hand Soap (manufactured by Kao Corporation, a container free of the content and cleaned with water several times over and dried was used) with the spray, and left at 25° C. for 20 minutes. Subsequently, they were rinsed with tap water for 1 minute with mechanical force at 300 rpm using a Leanuts tester, and then placed horizontally and dried overnight. The mass of each SUS plate for cleaning after drying was weighed on a 4-digit balance to give a mass after cleaning (Z).

A cleaning rate was calculated by the formula below from the initial mass (X), the mass before cleaning (Y) and the mass after cleaning (Z). The results are shown in Table 3.

Cleaning rate %)=[mass before cleaning(Y)−mass after cleaning(Z)]/[mass before cleaning(Y)−initial mass(X)]×100

### <Appearance Evaluation>

40 mL of each prepared cleaning agent composition in Tables 1 to 3 was filled into a 50-mL sample bottle (No. 6 wide-mouth standard bottle, made of glass, a cylindrical shape with a diameter of 40 mm and a height of 80 mm, letters for checking evaluations were printed on the circumferential surface of the bottle) and covered with a lid, and then, left to stand within a thermostatic chamber at 25° C. for 1 hour. The appearance of the composition after leaving it to stand was visually observed and determined in accordance with the criteria below. The results are shown in Tables 1 to 3.
Transparent: a state in which the composition is not turbid, and the letters are clearly visible over the sample bottle
Cloudy and thickened: a state in which the composition is turbid and thickened, and the letters are not visible at all over the sample bottle

TABLE 1

| | | | | | Example | | | | | | |
|---|---|---|---|---|---|---|---|---|---|---|---|
| | | | | | 1 | 2 | 3 | 4 | 5 | 6 | 7 |
| Cleaning | Formu- | (a) | (a1) | AMIET 102 | 2 | 2 | 2 | 2 | 2 | 2 | 2 |
| agent | lation | | | AMIET 105 | | | | | | | |
| compo- | compo- | | | AMIET 302 | | | | | | | |
| sition | sition | | (a2) | AMPHITOL | 1 | 1 | 1 | 1 | 1 | 1 | 1 |
| | (mass %) | | | 20N | | | | | | | |
| | | | | AMPHITOL | 2 | 2 | 2 | 2 | 2 | 2 | 2 |
| | | | | 40N | | | | | | | |
| | | | | AMPHITOL | 0.4 | 0.4 | 0.4 | 0.4 | 0.4 | 0.4 | 0.4 |
| | | | | 08N | | | | | | | |
| | | | (a3) | AG-124 | 2.5 | 2.5 | 2.5 | 2.5 | 2.5 | 2.5 | 2.5 |
| | | | (a4) | GE-EH | 0.83 | 0.83 | 0.83 | 0.83 | 0.83 | 0.83 | 0.83 |

| | | | | | | | | |
|---|---|---|---|---|---|---|---|---|
| (b) | SANISOL B-50 | 0.01 | 0.05 | 0.1 | 0.5 | 1 | 2 | 0.1 |
| | LEVENOL RK | | | | | | | |
| | SANISOL 08 | | | | | | | |
| | QUARTAMIN 60W | | | | | | | |
| (c) | Citric acid | 1 | 1 | 1 | 1 | 1 | 1 | |
| | Malic acid | | | | | | | 1 |
| | MGDA | | | | | | | |
| | GLDA | | | | | | | |
| | EDTA | | | | | | | |
| (d) | NEOPELEX G-25 | | | | | | | |
| (e) | BDG | 1 | 1 | 1 | 1 | 1 | 1 | 1 |
| | PPG-1000 | 0.1 | 0.1 | 0.1 | 0.1 | 0.1 | 0.1 | 0.1 |

| Water | Bal- | Bal- | Bal- | Bal- | Bal- | Bal- | Bal- |
|---|---|---|---|---|---|---|---|
| | ance | ance | ance | ance | ance | ance | ance |
| Total | 100 | 100 | 100 | 100 | 100 | 100 | 100 |

| | | | | | | | |
|---|---|---|---|---|---|---|---|
| pH (20° C.) | 7.1 | 7.1 | 7.1 | 7.1 | 7.1 | 7.1 | 7.1 |
| (b)/(c) (mass ratio) | 0.01 | 0.05 | 0.10 | 0.50 | 1.00 | 2.00 | 0.10 |
| (a1)/(b) (mass ratio) | 200.0 | 40.0 | 20.0 | 4.0 | 2.0 | 1.0 | 20.0 |
| (a1)/(c) (mass ratio) | 2.0 | 2.0 | 2.0 | 2.0 | 2.0 | 2.0 | 2.0 |
| (a1)/(a) (mass %) | 23 | 23 | 23 | 23 | 23 | 23 | 23 |
| (d)/((a1) + (b)) (mass %) | 0 | 0 | 0 | 0 | 0 | 0 | 0 |
| (d)/all surfactants (mass %) | 0 | 0 | 0 | 0 | 0 | 0 | 0 |

| | | | | | | | |
|---|---|---|---|---|---|---|---|
| Denatured oil cleaning power | 57.55 | 58.49 | 76.81 | 75.3 | 63.59 | 52.4 | 63.6 |
| 1 (%) (20 times diluted | | | | | | | |
| cleaning liquid) | | | | | | | |
| Appearance | Trans- | Trans- | Trans- | Trans- | Trans- | Trans- | Trans- |
| evaluation | parent | parent | parent | parent | parent | parent | parent |

| | | | | | Example | | | | | |
|---|---|---|---|---|---|---|---|---|---|---|
| | | | | | 8 | 9 | 10 | 11 | 12 | 13 |
| Cleaning | Formu- | (a) | (a1) | AMIET 102 | 2 | 2 | 2 | 2 | | |
| agent | lation | | | AMIET 105 | | | | | 2 | |
| compo- | compo- | | | AMIET 302 | | | | | | 2 |
| sition | sition | | (a2) | AMPHITOL | 1 | 1 | 1 | 1 | 1 | 1 |
| | (mass %) | | | 20N | | | | | | |
| | | | | AMPHITOL | 2 | 2 | 2 | 2 | 2 | 2 |
| | | | | 40N | | | | | | |
| | | | | AMPHITOL | 0.4 | 0.4 | 0.4 | 0.4 | 0.4 | 0.4 |
| | | | | 08N | | | | | | |
| | | | (a3) | AG-124 | 2.5 | 2.5 | 2.5 | 2.5 | 2.5 | 2.5 |
| | | | (a4) | GE-EH | 0.83 | 0.83 | 0.83 | 0.83 | 0.83 | 0.83 |

| | | | | | | | |
|---|---|---|---|---|---|---|---|
| (b) | SANISOL B-50 | 0.1 | 0.1 | 0.5 | 0.1 | 0.5 | 0.5 |
| | LEVENOL RK | | | | | | |
| | SANISOL 08 | | | | | | |
| | QUARTAMIN 60W | | | | | | |
| (c) | Citric acid | | | | | 1 | 1 |
| | Malic acid | | | | | | |
| | MGDA | 1 | | | | | |
| | GLDA | | 1 | 1 | | | |
| | EDTA | | | | 1 | | |
| (d) | NEOPELEX G-25 | | | | | | |
| (e) | BDG | 1 | 1 | 1 | 1 | 1 | 1 |
| | PPG-1000 | 0.1 | 0.1 | 0.1 | 0.1 | 0.1 | 0.1 |

| Water | Bal- | Bal- | Bal- | Bal- | Bal- | Bal- |
|---|---|---|---|---|---|---|
| | ance | ance | ance | ance | ance | ance |
| Total | 100 | 100 | 100 | 100 | 100 | 100 |

| | | | | | | |
|---|---|---|---|---|---|---|
| pH (20° C.) | 7.1 | 7.1 | 7.1 | 7.1 | 7.1 | 7.1 |
| (b)/(c) (mass ratio) | 0.10 | 0.10 | 0.50 | 0.10 | 0.50 | 0.50 |
| (a1)/(b) (mass ratio) | 20.0 | 20.0 | 4.0 | 20.0 | 4.0 | 4.0 |
| (a1)/(c) (mass ratio) | 2.0 | 2.0 | 2.0 | 2.0 | 2.0 | 2.0 |
| (a1)/(a) (mass %) | 23 | 23 | 23 | 23 | 23 | 23 |
| (d)/((a1) + (b)) (mass %) | 0 | 0 | 0 | 0 | 0 | 0 |
| (d)/all surfactants (mass %) | 0 | 0 | 0 | 0 | 0 | 0 |

| | | | | | | |
|---|---|---|---|---|---|---|
| Denatured oil cleaning power | 54.18 | 50.79 | 69.69 | 65.39 | 76.01 | 67.16 |
| 1 (%) (20 times diluted | | | | | | |
| cleaning liquid) | | | | | | |
| Appearance | Trans- | Trans- | Trans- | Trans- | Trans- | Trans- |
| evaluation | parent | parent | parent | parent | parent | parent |

TABLE 2

| | | | | | Example | | | | | | |
|---|---|---|---|---|---|---|---|---|---|---|---|
| | | | | | 14 | 15 | 16 | 17 | 18 | 19 | 20 |
| Cleaning | Formu- | (a) | (a1) | AMIET 102 | 2 | 2 | 2 | 5 | 2 | 2 | 2 |
| agent | lation | | | AMIET 105 | | | | | | | |
| compo- | compo- | | | AMIET 302 | | | | | | | |
| sition | sition | | (a2) | AMPHITOL | 1 | 1 | 1 | 2.5 | 1 | 1 | 1 |
| | (mass %) | | | 20N | | | | | | | |
| | | | | AMPHITOL | 2 | 2 | 2 | 5 | 2 | 2 | 2 |
| | | | | 40N | | | | | | | |
| | | | | AMPHITOL | 0.4 | 0.4 | 0.4 | 0.4 | | 0.4 | 0.4 |
| | | | | 08N | | | | | | | |
| | | | (a3) | AG-124 | 2.5 | 2.5 | 2.5 | 2.5 | | 2.5 | 2.5 |
| | | | (a4) | GE-EH | 0.83 | 0.83 | 0.83 | 0.83 | | 0.83 | 0.83 |

| | | | | | | | | |
|---|---|---|---|---|---|---|---|---|
| (b) | SANISOL B-50 | | | | 0.5 | 0.5 | 0.5 | 2 |
| | LEVENOL RK | 0.5 | | | | | | |
| | SANISOL 08 | | 0.5 | | | | | |
| | QUARTAMIN 60W | | | 0.5 | | | | |
| (c) | Citric acid | 1 | 1 | 1 | 1 | 1 | 1 | 1 |
| | Malic acid | | | | | | | |
| | MGDA | | | | | | | |
| | GLDA | | | | | | | |
| | EDTA | | | | | | | |
| (d) | NEOPELEX G-25 | | | | | | 0.25 | 1.1 |
| (e) | BDG | 1 | 1 | 1 | 1 | 1 | 1 | 1 |
| | PPG-1000 | 0.1 | 0.1 | 0.1 | 0.1 | 0.1 | 0.1 | 0.1 |

| | | | | | | | |
|---|---|---|---|---|---|---|---|
| Water | Bal- | Bal- | Bal- | Bal- | Bal- | Bal- | Bal- |
| | ance | ance | ance | ance | ance | ance | ance |
| Total | 100 | 100 | 100 | 100 | 100 | 100 | 100 |

| | | | | | | | |
|---|---|---|---|---|---|---|---|
| pH (20° C.) | 7.1 | 7.1 | 7.1 | 7.1 | 7.1 | 7.1 | 7.1 |
| (b)/(c) (mass ratio) | 0.50 | 0.50 | 0.50 | 0.50 | 0.50 | 0.50 | 2.00 |
| (a1)/(b) (mass ratio) | 4.0 | 4.0 | 4.0 | 10.0 | 4.0 | 4.0 | 1.0 |
| (a1)/(c) (mass ratio) | 2.0 | 2.0 | 2.0 | 5.0 | 2.0 | 2.0 | 2.0 |
| (a1)/(a) (mass %) | 23 | 23 | 23 | 31 | 40 | 23 | 23 |
| (d)/((a1) + (b) (mass %) | 0.0 | 0.0 | 0.0 | 0.0 | 0.0 | 10.0 | 27.5 |
| (d)/all surfactants (mass %) | 0.0 | 0.0 | 0.0 | 0.0 | 0.0 | 2.6 | 9.3 |

| | | | | | | | |
|---|---|---|---|---|---|---|---|
| Denatured oil cleaning power | 75.27 | 67.54 | 71.43 | 69.73 | 76.65 | 71.53 | 70.77 |
| 1 (%) (20 times diluted | | | | | | | |
| cleaning liquid) | | | | | | | |
| Appearance | Trans- | Trans- | Trans- | Trans- | Trans- | Trans- | Trans- |
| evaluation | parent | parent | parent | parent | parent | parent | parent |

| | | | | | Comparative example | | | | |
|---|---|---|---|---|---|---|---|---|---|
| | | | | | 1 | 2 | 3 | 4 | 5 |
| Cleaning | Formu- | (a) | (a1) | AMIET 102 | 2 | 2 | 2 | 2 | 2 |
| agent | lation | | | AMIET 105 | | | | | |
| compo- | compo- | | | AMIET 302 | | | | | |
| sition | sition | | (a2) | AMPHITOL | 1 | 1 | 1 | 1 | 1 |
| | (mass %) | | | 20N | | | | | |
| | | | | AMPHITOL | 2 | 2 | 2 | 2 | 2 |
| | | | | 40N | | | | | |
| | | | | AMPHITOL | 0.4 | 0.4 | 0.4 | 0.4 | 0.4 |
| | | | | 08N | | | | | |
| | | | (a3) | AG-124 | 2.5 | 2.5 | 2.5 | 2.5 | 2.5 |
| | | | (a4) | GE-EH | 0.83 | 0.83 | 0.83 | 0.83 | 0.83 |

| | | | | | | |
|---|---|---|---|---|---|---|
| (b) | SANISOL B-50 | | 0.5 | 1 | 2 | 2 |
| | LEVENOL RK | | | | | |
| | SANISOL 08 | | | | | |
| | QUARTAMIN 60W | | | | | |
| (c) | Citric acid | 1 | | | | 1 |
| | Malic acid | | | | | |
| | MGDA | | | | | |
| | GLDA | | | | | |
| | EDTA | | | | | |
| (d) | NEOPELEX G-25 | | | | | 2 |
| (e) | BDG | 1 | 1 | 1 | 1 | 1 |
| | PPG-1000 | 0.1 | 0.1 | 0.1 | 0.1 | 0.1 |

| | | | | | |
|---|---|---|---|---|---|
| Water | Bal- | Bal- | Bal- | Bal- | Bal- |
| | ance | ance | ance | ance | ance |
| Total | 100 | 100 | 100 | 100 | 100 |

| | | | | | |
|---|---|---|---|---|---|
| pH (20° C.) | 7.1 | 7.1 | 7.1 | 7.1 | 7.1 |
| (b)/(c) (mass ratio) | 0.00 | — | — | — | 2.00 |
| (a1)/(b) (mass ratio) | — | 4.0 | 2.0 | 1.0 | 1.0 |
| (a1)/(c) (mass ratio) | 2.0 | — | — | — | 2.0 |
| (a1)/(a) (mass %) | 23 | 23 | 23 | 23 | 23 |
| (d)/((a1) + (b) (mass %) | 0.0 | 0.0 | 0.0 | 0.0 | 50.0 |
| (d)/all surfactants (mass %) | 0.0 | 0.0 | 0.0 | 0.0 | 15.7 |

| | | | | | |
|---|---|---|---|---|---|
| Denatured oil cleaning power | 45.87 | 49.32 | 48.24 | 37.15 | 37.94 |
| 1 (%) (20 times diluted | | | | | |
| cleaning liquid) | | | | | |
| Appearance | Trans- | Trans- | Trans- | Trans- | Cloudy and |
| evaluation | parent | parent | parent | parent | thickened |

TABLE 3

| | | | | | | Compar- |
|---|---|---|---|---|---|---|
| | | | | | | ative |
| | | | | | Example | example |
| | | | | | 21 | 6 |
| Cleaning | Formu- | (a) | (a1) | AMIET 102 | 2 | 2 |
| agent | lation | | (a2) | AMPHITOL | 1 | 1 |
| compo- | compo- | | | 20N | | |
| sition | sition | | | AMPHITOL | 2 | 2 |
| | (mass %) | | | 40N | | |
| | | | | AMPHITOL | 0.4 | 0.4 |
| | | | | 08N | | |
| | | | (a3) | AG-124 | 2.5 | 2.5 |
| | | | (a4) | GE-EH | 0.83 | 0.83 |

| | | | |
|---|---|---|---|
| (b) | SANISOL B-50 | 0.5 | 2 |
| (c) | Citric acid | 1 | |
| (e) | BDG | 1 | 1 |
| | PPG-1000 | 0.1 | 0.1 |

| | | |
|---|---|---|
| Water | Bal- | Bal- |
| | ance | ance |
| Total | 100 | 100 |

| | | |
|---|---|---|
| pH (20° C.) | 7.1 | 7.1 |
| (b)/(c) (mass ratio) | 0.5 | — |
| (a1)/(b) (mass ratio) | 4 | 1 |
| (a1)/(c) (mass ratio) | 2 | — |
| (a1)/(a) (mass %) | 23 | 23 |

| | | |
|---|---|---|
| Denatured oil cleaning power | 89.34 | 47.60 |
| 1 (%) (20 times diluted | | |
| cleaning liquid) | | |
| Denatured oil cleaning power | 90.66 | 64.31 |
| 2 (%) (cleaning with foam | | |
| of raw solution) | | |
| Appearance | Trans- | Trans- |
| evaluation | parent | parent |

1. A cleaning agent composition comprising, (a) a nonionic surfactant [hereinafter referred to as component (a)] containing a polyoxyalkylene alkyl or alkenyl amine [hereinafter referred to as component (a1)] in which the alkyl group or alkenyl group has 8 or more and 18 or less carbons and the oxyalkylene group has an average number of added moles of 1 or more and 8 or less, (b) a quaternary ammonium salt-type surfactant [hereinafter referred to as component (b)], (c) a polycarboxylic acid or a salt thereof [hereinafter referred to as component (c)] and water, wherein a content of (d) an anionic surfactant [hereinafter referred to as component (d)] is less than 35 mass % relative to a total content of the components (a1) and (b), and the content of the component (d) is 20 mass % or less relative to a content of all surfactants.

2. The cleaning agent composition according to claim 1, wherein a content of the component (a1) in the component (a) is 10 mass % or more and 100 mass % or less.

3. The cleaning agent composition according to claim 1, wherein the component (c) has a molecular weight of 100 or more and 300 or less in terms of an acid equivalent form, and is a divalent or more and tetravalent or less polycarboxylic acid or a salt thereof.

4. The cleaning agent composition according to claim 1, wherein a mass ratio of a content of the component (b) to a content of the component (c), (b)/(c), is 0.01 or more and 5 or less.

5. The cleaning agent composition according to claim 1, wherein a mass ratio of a content of the component (a1) to a content of the component (b), (a1)/(b), is 0.1 or more and 200 or less.

6. The cleaning agent composition according to claim 1, wherein a mass ratio of a content of the component (a1) to a content of the component (c), (a1)/(c), is 0.1 or more and 10 or less.

7. The cleaning agent composition for hard articles according to claim 1, wherein the component (a) comprises one or more selected from (a2) an amine oxide-type surfactant, (a3) an alkyl glycoside-type surfactant and (a4) an alkyl glyceryl ether-type surfactant.

8. The cleaning agent composition according to claim 1, wherein the composition is used for hard articles.

9. A method for cleaning a denatured oil stain comprising, bringing the cleaning agent composition according to claim 1 or a cleaning liquid obtained by diluting the same with water into contact with a hard article adhered with an oil stain including a denatured oil stain.

10. The method for cleaning a denatured oil stain according to claim 9, wherein the cleaning agent composition is foamed and brought into contact with the hard article.

11. The method for cleaning a denatured oil stain according to claim 10, wherein the cleaning agent composition is foamed with a sponge or foamed with a sprayer having a foam forming mechanism and brought into contact with the hard article.
